(19) United States
(12) Patent Application Publication
(10) Pub. No.: US 2007/0292112 A1
(43) Pub. Date: Dec. 20, 2007

(54) SEARCHING METHOD OF SEARCHING HIGHLIGHT IN FILM OF TENNIS GAME

(76) Inventors: Shih-Hung Lee, Taipei City (TW); Chia-Hung Yeh, Tai-Nan City (TW); Hsuan-Huei Shih, Taipei City (TW); Chung-Chieh Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/424,536

(22) Filed: Jun. 15, 2006

(51) Int. Cl. H04N 7/00

(52) U.S. Cl. 386/95

(57) ABSTRACT

A searching method of searching a highlight in a film of a tennis game is disclosed. The searching method includes: detecting a plurality of long-field-view shots in the film; and utilizing audio energy of the long-field-view shots to determine the highlight.

### BACKGROUND OF THE INVENTION

1. Field of the Invention

The present invention relates to a searching method for searching a highlight in a tennis game film, and more specifically, to a searching method utilizing audio energy of long-field-view shots in the tennis game to decide the highlight.

2. Description of the Prior Art

In a sport game, a lot of time is usually wasted on interviews, introduction, and advertisements. An audience needs highlights to determine if the game is exciting, or to be informed as to the content. Actually, interesting play occurs intermittently in sports game. Therefore, it is more convenient for users to utilize software to extract highlights from a sport film. Taking a tennis game as an example, segments or shots during a rally can be extracted as desirable highlights, while some other segments or shots in the tennis game might also be interesting.

As mentioned, the users may utilize software, for example, certain application programs executed in a personal computer, to extract highlights from a sport film. However, it still takes efforts of the users who utilize the application programs to perform video editing manually since an application program of this kind is typically an editing tool without an automatically editing function.

### SUMMARY OF THE INVENTION

It is therefore one of the objectives of the claimed invention to provide a searching method utilizing audio energy of long-field-view shots in a tennis game to determine the highlights, in order to achieve the automatically editing function mentioned above.

According to the claimed invention, a searching method of searching a highlight in a tennis game film is disclosed. The method includes detecting a plurality of long-field-view shots in the film, and utilizing audio energy of the long-field-view shots to determine the highlight.

It is an advantage of the claimed invention that the searching method utilizes not only video features to detect a plurality of long-field-view shots in the film but also utilizes audio features such as the audio energy to determine highlights from amongst the long-field-view shots. As both audio and video features are applied to detect the tennis highlights, the performance will be better to fit the user's requirements.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a searching method of searching a highlight in a film of a tennis game according to one embodiment of the present invention.

FIG. 2 is a table illustrating histogram differences between different key frames from shots of the film.

### DETAILED DESCRIPTION

During a tennis game, the camera is typically fixed in the position behind a player, so the whole court can be seen clearly most of the time. The fixed view (i.e., the view fixed in the position behind a player) is typically a long field view. According to the present invention, certain video features in this situation are referable and can be utilized for extracting at least a portion of the highlights. In addition, audio energy can be utilized to identify applause during the long-field-view shots to further determine the highlights. In the tennis game, as players may have unsuccessful serves, the present invention may also filter out segments of these unsuccessful serves (which can be referred to as the unsuccessful serve segments or simply referred to as the unsuccessful segments) to ensure the best selection of highlights.

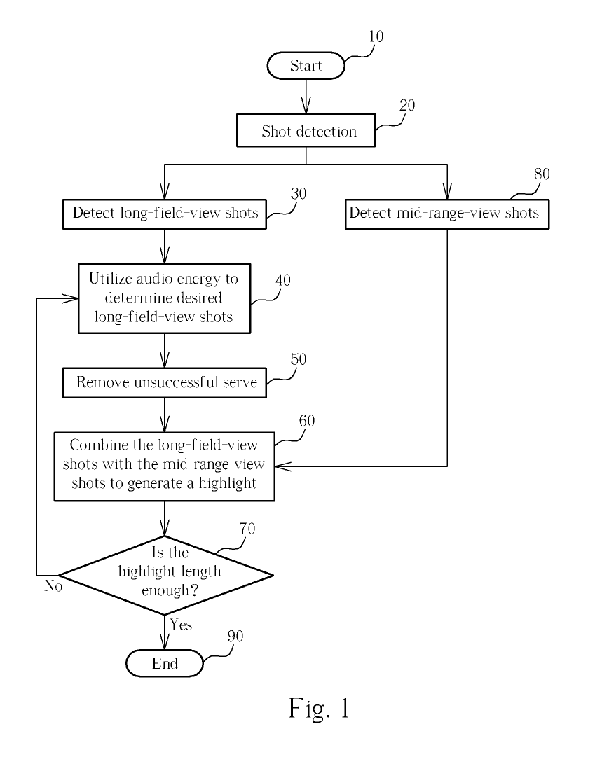

Please refer to FIG. 1. FIG. 1 is a flowchart of a preferred embodiment of a searching method of searching a highlight in a film of a tennis game according to the present invention. The steps of the searching method are described as follows:

Step 10: Start.

Step 20: Analyze a tennis game film by performing shot detection to classify the film into a plurality of shots. The implementation of the shot detection is well known by those skilled in the art, and therefore not explained in detail here. After executing Step 20,step 30 and step 80 can be further executed.

Step 30: Detect long-field-view shots from the plurality of shots.

Step 40: Utilize audio energy of the long-field-view shots to determine desired long-field-view shots belonging to the highlights.

Step 50: Analyze a hit sound in order to detect an unsuccessful serve in the desired long-field-view shots, and once an unsuccessful serve is detected, remove the unsuccessful segment of the unsuccessful serve from the desired long-field-view shots. Typically, an unsuccessful serve locates in the beginning of a shot.

Step 60: Combine specific shots (not belonging to the long-field-view shots) and the desired long-field-view shots to make a complete and continuous highlight.

Step 70: Determine whether the highlight length reaches a desired highlight length set by user(s). If the highlight length is enough, enter step 90; otherwise, execute step 40. As a result, all the desired shots are collected to form the whole highlights.

Step 90: End.

Please note that, in step 50, a method to detect the unsuccessful serve in the tennis game film is disclosed in the invention. Because the player has to serve again after the unsuccessful serve, there is a long time interval between the first hit sound of this new serve and the previous hit sound. Therefore, the unsuccessful segment could be detected through detecting the gap after first few hit sounds. More specifically, by detecting the long time interval which is between the last one of the first few hit sounds and the hit sound of the new serve after the segment, the unsuccessful segment could be detected. The unsuccessful serve segment is also part of a long-field-view shot, but is not a highlight shot that viewers desire to see, so the detected unsuccessful serve segment will be removed. Additionally, in step 60, the specific shots can be inserted between two adjacent desired long-field-view shots to smooth the highlights.

Due to the long-field-view shots being the most important characteristic of a tennis highlight, the key point is how to detect the long-field-view shots in a tennis game film. The present invention discloses four methods to accomplish this objective. Tennis courts are classified into three types: clay, grass, and hard court. Each of these three courts has a corresponding background color. For example, a clay court is red, a grass court is light green, and a hard court is deep green. Because the long-field view includes the whole court in order to see both competing players in the same picture, the long-field-view shot can be detected according to the court color.

The first method directly analyzes color distribution of each shot in the film to select the shots whose most frames have a large area with the same color. Since long-field-view shots occur the most frequently and most of their area belongs to the court, they will dominate the selected shots. Hence, we could get a color that occurs most frequently in these selected shots. If a selected shot has the same dominating color, it is classified as a long-field-view shot.

The second method finds a key frame to represent the characteristic of the long-field view from the film, and compares the key frame with the middle frame of each shot in the film to check whether the shot conforms to the long-field-view shot. In the other word, if the middle frame of the shot can stand for the characteristic of the shot, and if the middle frame is similar to the key frame substantially, then it can be said that this shot is a long-field-view shot. Please note that this method is not limited to choose the middle frame of the shot to compare with the key frame; in fact, any frame in the shot is allowed to be the delegate.

There are many methods to decide the key frame from the film, and the present invention discloses a method to identify the key frame. Firstly, as the beginning and end of a tennis match film usually include interviews, introductions, or advertisements, they are not mainly composed of the long-field-view. Therefore, the starting part and the ending part of the film are ignored and, for example, only middle 10 minutes of the film is considered. Next, short shots are ignored because short shots are usually not interesting. That is, only shots that lasts for more than a preset time (for example, 10 seconds) are chosen from the film. Finally, a specific shot is selected from the shots that last more than the preset time. For example, users could select the shot through an interaction interface. Again, a representative frame, such as a middle frame, from the specific shot is selected as the key frame. This method directly selects one frame to assign as the key frame, ignores other frames in the same shot.

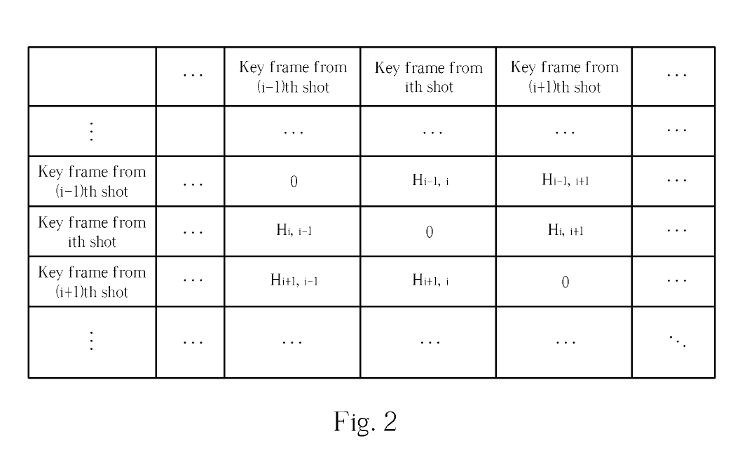

Another method disclosed in the present invention automatically decides a desired key frame. Similarly, the starting part and the ending part of the film are ignored, and the middle frame of the remaining shots is chosen as the key frame. For each key frame, histogram differences are calculated between the key frame and other key frames respectively, and then the histogram differences are accumulated to generate a difference value. Continuously, a key frame having a smallest difference value is chosen as the desired key frame. For an illustrated example of this method, please refer to FIG. 2. FIG. 2 is a table illustrating histogram differences between different key frames from shots of the film. Histogram differences H among key frames are calculated, where the ith column represents the histogram differences between the ith key frame and other key frames. For example, H_{i-1,i} represents the histogram differences between the key frame from (i-1)th shot and the key frame from ith shot. Next, the elements in each column are summed up to generate difference values corresponding to each column. The difference values indicate similarity of the key frame to other key frames, that is, a small difference value means that the key frame is similar to most of the other key frames. Finally, a key frame having a smallest difference value is chosen as the desired key frame that represents the characteristic of the long-field view in the film.

The third method utilized to detect the long-field-view shot finds the desired key frame and several key frames (for example, 5 key frames) having the smallest histogram differences with the desired key frame, and builds a color model of a court according to these selected key frames. Because most area in a long-field-view shot belongs to the court and follows the color model, the color model can illustrate the characteristics of the long-field-view shot. Through comparing the middle frame of each shot in the film with the color model, the long-field-view shot is detected. The color model includes color information and can be built in a well-known HSV domain.

The fourth method utilized to detect the long-field-view shot also applies a color model to detect the long-field-view shot, but the color model is preset. As mentioned above, there are three kinds of tennis courts, so three color models respectively corresponding to three kinds of tennis courts can be identified. Again, through comparing the middle frame of each shot in the film with the color model, the long-field-view shot is detected.

After selecting the long-field-view shots from the film, audio energy features such as clapping and shouting of players and the crowd are utilized to determine a highlight that corresponds more accurately to viewers' expectations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A searching method of searching a highlight in a film of a tennis game, the searching method comprising:
detecting a plurality of long-field-view shots in the film; and
utilizing audio energy of the long-field-view shots to determine the highlight.

2. The searching method of claim 1, wherein the step of detecting the long-field-view shots comprises:
analyzing color distribution of each shot in the film; and
choosing a shot having a specific color distribution as the long-field-view shot.

3. The searching method of claim 1, wherein the step of detecting the long-field-view shots comprises:
finding a key frame from the film;
finding a frame of a shot in the film; and
comparing the frame with the key frame to determine if the shot is a long-field-view shot.

4. The searching method of claim 3, wherein the frame is a middle frame of the shot.

5. The searching method of claim 3, wherein the step of finding the key frame from the film comprises:
choosing at least a specific shot that lasts for more than a preset time from the film;
choosing a representative frame from the specific shot as the key frame.

6. The searching method of claim 5, wherein the representative frame is a middle frame of the specific shot.

7. The searching method of claim 5, wherein the step of choosing the specific shot comprises:
ignoring a starting part and an ending part of the film; and
selecting the specific shot that lasts for more than the preset time from the film.

8. The searching method of claim 1, wherein the step of detecting the long-field-view shots comprises:
finding at least a desired key frame from the film;
deciding a color model of a court according to the desired key frame;
finding a frame of a shot in the film; and
comparing the frame with the color model to detect a long-field-view shot.

9. The searching method of claim 8, wherein the frame is a middle frame of the shot.

10. The searching method of claim 8, wherein the step of choosing the specific shot comprises:
ignoring a starting part and an ending part of the film; and
selecting the specific shot that lasts for more than the preset time from the film.

11. The searching method of claim 8, wherein the step of finding the desired key frame from the film comprises:
for each key frame, calculating histogram differences between the key frame and other key frames respectively, and accumulating the histogram differences to generate a difference value; and
choosing a key frame having a smallest difference value as the desired key frame.

12. The searching method of claim 11, wherein the key frame is a middle frame of a shot.

13. The searching method of claim 1, wherein the step of detecting the long-field-view shots comprises:
determining a preset color model;
finding a frame of a shot in the film; and
comparing the frame with the preset color model to detect if the shot is a long-field-view shot.

14. The searching method of claim 13, wherein the frame is a middle frame of the shot.

15. The searching method of claim 1, further comprising:
analyzing a hit sound to detect an unsuccessful segment of a shot in the highlight; and
removing the unsuccessful segment of a shot from the highlight.

16. The searching method of claim 15, wherein the step of analyzing the hit sound to detect the unsuccessful segment of a shot comprises:
detecting an undesired segment in a shot by detecting a long time interval which is between the last one of the first few hit sounds and the hit sound of the next serve after the segment.

17. The searching method of claim 1, wherein the step of utilizing audio energy of the long-field-view shots to decide the highlight comprises:
determining desired long-field-view shots belonging to the highlight by utilizing audio energy of the long-field-view shots;
and the method further comprises:
adding specific shots to the desired long-field-view shots to satisfy a desired highlight length.

18. The searching method of claim 17, wherein the specific shots are inserted into two desired long-field-view shots.
